(19) United States
(12) Patent Application Publication
(10) Pub. No.: US 2010/0085192 A1
(43) Pub. Date: Apr. 8, 2010

(54) THEFT DETERRENT DEVICE WITH ONBOARD ALARM

(75) Inventors: Keith C. Nagelski, Huntersville, NC (US); Mitchell S. Goldstein, Rock Hill, SC (US); Ian R. Scott, Duluth, GA (US)

Correspondence Address: SAND & SEBOLT, AEGIS TOWER, SUITE 1100, 4940 MUNSON STREET, NW, CANTON, OH, 44718-3615, US

(73) Assignee: CHECKPOINT SYSTEMS, INC., Thorofare, NJ (US)

(21) Appl. No.: 12/635,287

(22) Filed: Dec. 10, 2009

Related U.S. Application Data
(63) Continuation of application No. 11/607,671, filed on Dec. 1, 2006.
(60) Provisional application No. 60/755,669, filed on Dec. 29, 2005.

(51) Int. Cl. G08B 13/14

(52) U.S. Cl. 340/572.9

(57) ABSTRACT

A theft deterrent tag includes a first tag element having a post and a second tag element for receiving the post to secure the tag elements together on an item of merchandise. Spaced electrical contacts within the second tag element receive therebetween the post, which abuts each of the electrical contacts to provide an electrical pathway between the contacts to close a first electrical circuit which turns the device on. The first tag element includes a head which depresses a plunger switch to arm the device. The device is configured to sound an onboard alarm in response to prying of the head or cutting of the post of the first tag element, or if an EAS tag receives a wireless signal from a security gate. Security gate alarms also sound if the tag moves through the gate or within a predetermined distance thereof.

### CROSS REFERENCE TO RELATED APPLICATIONS

This application is a continuation of U.S. patent application Ser. No. 11/607,671, filed Dec. 1, 2006; which application claims priority from U.S. Provisional Patent Application Ser. No. 60/755,669, filed Dec. 29, 2005; the disclosures of which are incorporated herein by reference.

### BACKGROUND OF THE INVENTION

1. Technical Field

The invention relates generally to theft deterrent devices. More particularly, the invention relates to such a device with an onboard alarm. Specifically, the invention relates to such a tag which also causes a gate security alarm to sound.

2. Background Information

Within the field of theft deterrent devices, various alarming devices are known. However, it is desirable to have a theft deterrent device which provides multiple alarms in order to provide redundancy so that if one of the alarm systems fails, one or more additional alarm systems or aspects will nonetheless provide an alarm to alert store personnel of a potential theft. It is also desirable to provide such a device while maintaining a configuration that is as simple as possible. One example of a theft deterrent device having some of these characteristics is described in U.S. Pat. No. 6,535,130 granted to Nguyen et al. The theft deterrent device of said patent utilizes a tack assembly which is insertable into a body of a tag. The device has a tack switch, a plunger switch and an on/off switch in order to provide the desired electrical circuitry for alarming the device. However, there is a desire in the art to simplify this configuration. The theft deterrent device of the present invention solves this problem while providing multiple alarms.

### BRIEF SUMMARY OF THE INVENTION

The present invention provides a security tag comprising a first tag element comprising a post; a second tag element securable to the first tag element in a secured position; a pair of spaced electrical contacts carried by the second tag element; a post-receiving opening formed in the second tag element for receiving the post therein in the secured position so that the post abuts each of the electrical contacts to provide an electrical pathway therebetween to close a first electrical circuit.

### BRIEF DESCRIPTION OF THE SEVERAL VIEWS OF THE DRAWINGS

FIG. 1 is a bottom plan view of the theft deterrent device of the present invention secured to a piece of material.

FIG. 2 is a top plan view of the device.

FIG. 3 is a section view taken on line 3-3 of FIG. 2.

FIG. 4 is a top plan view of the device with the upper member of the housing removed.

FIG. 5 is a fragmentary exploded sectional view showing the tack, the electrical contacts and the locking mechanism of the device prior to the insertion of the tack into the tag body.

FIG. 6 is a fragmentary sectional view similar to FIG. 5 showing the tack inserted into the body of the tag.

FIG. 7 is a sectional view of an area similar to FIG. 6 showing the depression of the plunger switch.

FIG. 8 is a diagrammatic view of the electrical circuitry of the device.

FIG. 9 is a flow chart showing the arming and de-arming sequence of the device.

Similar numbers refer to similar parts throughout the drawings.

### DETAILED DESCRIPTION OF THE INVENTION

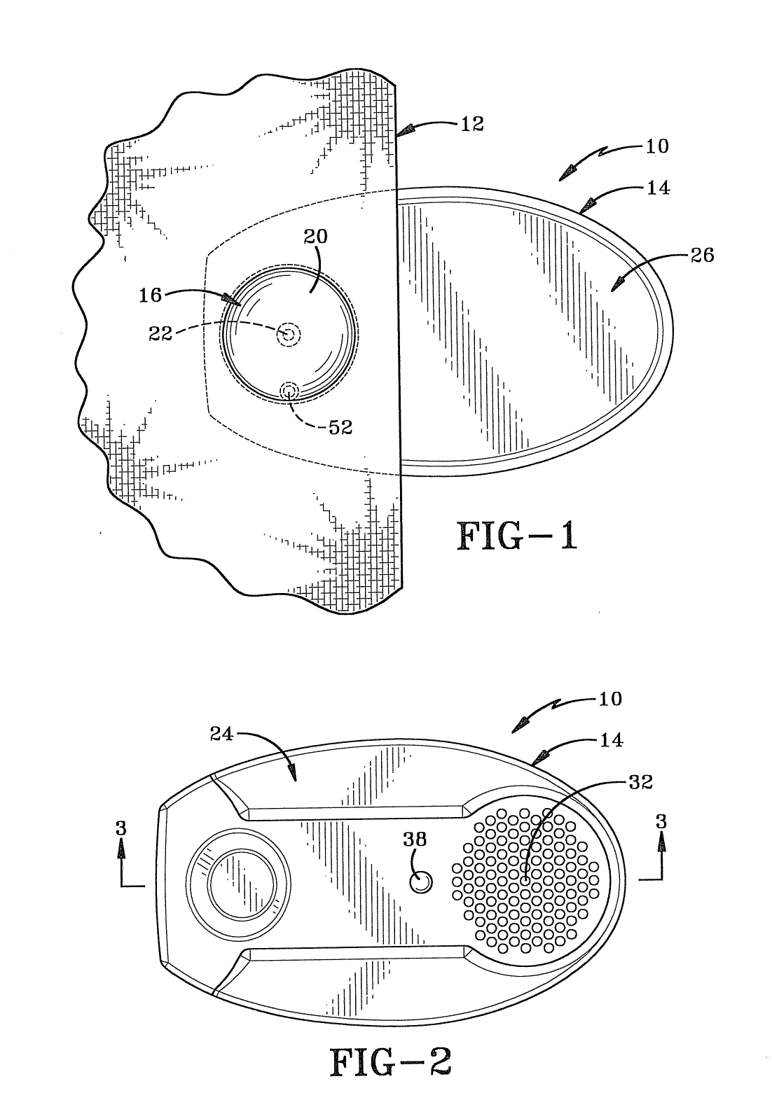

The theft deterrent device of the present invention is indicated generally at 10 in FIGS. 1-3. Device 10 is shown in FIG. 1 secured to a piece of material or cloth 12.

Device 10 includes a first member 14 and a second member 16 in the form of a tack having a head 20 and a pin or post 22 extending therefrom. Post 22 is inserted through cloth 12 into first member 14 in order to secure device 10 to cloth 12, which represents any article of merchandise to which device 10 may be secured. Device 10 is configured to sound an onboard alarm in the event that a potential thief attempts to remove device 10 from cloth 12 by, for instance, prying head 20 and/or cutting post 22. In addition, even if there is no tampering with device 10, it is configured for use with a security gate so that an alarm will sound as device 10 moves through the security gate or as it moves into a position within a certain range of the security gate. These various alarming characteristics and in particular when used with a security gate are described in greater detail in co-pending patent application entitled Electronic Security Device And System For Article Of Merchandise, filed on or about Dec. 20, 2005, the contents of which are incorporated herein by reference. Said application claims priority from provisional patent application having Ser. No. 60/639,770, filed on Dec. 28, 2004, the contents of which are also incorporated herein by reference.

Referring to FIG. 3, first member 14 of device 10 is further detailed. First member 14 includes upper and lower portions 24 and 26 which are secured to one another such as by sonic welding, glue etc. to form an interior chamber 28 therewithin. A piezo style speaker 30 is disposed in an interior chamber adjacent a plurality of speaker holes 32 formed in first member 14. Speaker 30 is configured to sound an audible alarm upon tampering with device 10. Speaker 30 is part of an alarm system which includes a battery 34, which is disposed in interior chamber 28 for powering the alarm system. The alarm system further includes a printed circuit board (PCB) 36 and a visual alarming indicator 38 in the form of an LED which is mounted within interior chamber 28 and extends through a hole in first member 14 so that a portion of indicator 38 is visible from external to device 10. Visual alarming indicator or LED 38 is typically configured to produce a blinking light when device 10 is in an armed state to warn potential thieves that the item of merchandise is protected by a theft deterrent device to further preclude even an attempt at theft.

First and second electrical contacts 40 and 42 are spaced from one another adjacent a post receiving opening 44 formed in lower portion 26 of first member 14.

More particularly, contacts 40 and 42 define therebetween a space 46 which is aligned with opening 44, each of which is configured to receive post 22 of tack 16 when first and second members 14 and 16 are secured to one another. Device 10 further includes a locking mechanism 48 in the form of a spring biased ball clutch mechanism for securing post 22 of tack 16 to lock first and second members 14 and 16 to one another. Device 10 further includes a plunger switch 50 having a plunger 52 (FIGS. 1 and 7) which is movable between non-depressed and depressed positions. An electrical article surveillance (EAS) tag 54 is disposed in interior chamber 28.

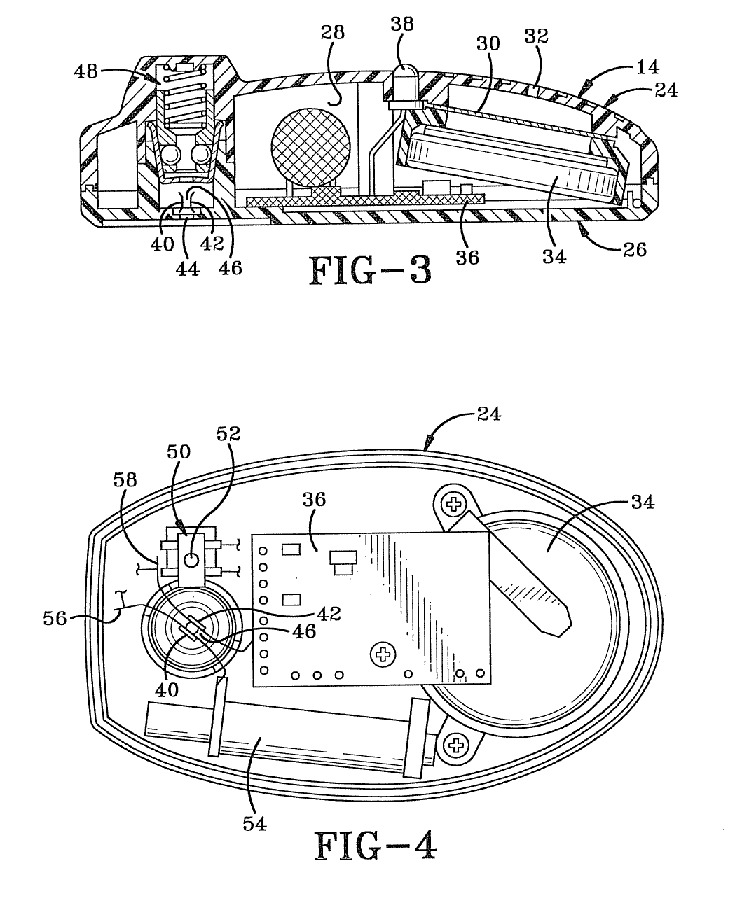

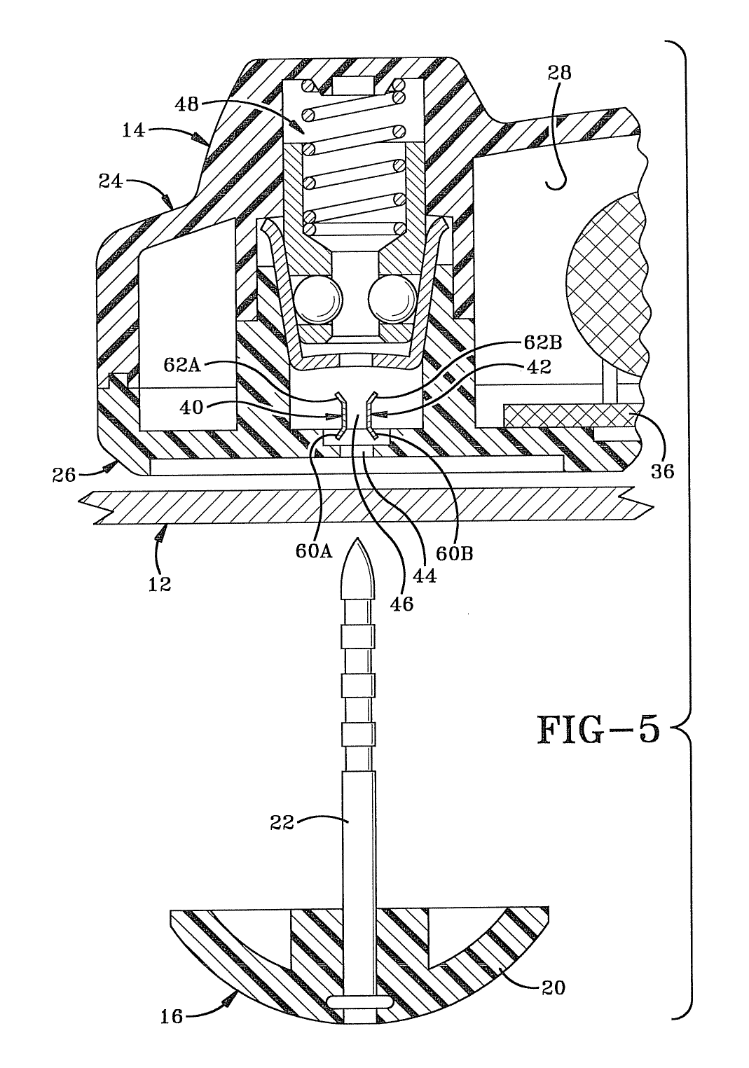

Referring to FIG. 4, electrical contacts 40 and 42 are respectively part of first and second resilient members 56 and 58 which are preferably formed of spring steel or the like. Members 56 and 58 are each formed of generally flat strips of spring metal each of which is generally configured in a shallow U-shape so that the base of each U-shaped member is adjacent one another with each U-shaped member opening away from one another. Members 56 and 58 are secured adjacent respective ends thereof to lower portion 26 of first member 14. The resilient nature of members 56 and 58 allows them to flex away from and toward one another in response to the insertion and removal of post 22 into and from space 46. Contacts 40 and 42 include respective lower flanges 60A and 60B and respective upper flanges 62A and 62B. Lower flanges 60A and 60B taper outwardly and downwardly to facilitate insertion of post 22 into space 46 and upper flanges 62 taper upwardly and outwardly to facilitate removal of post 22 through space 46.

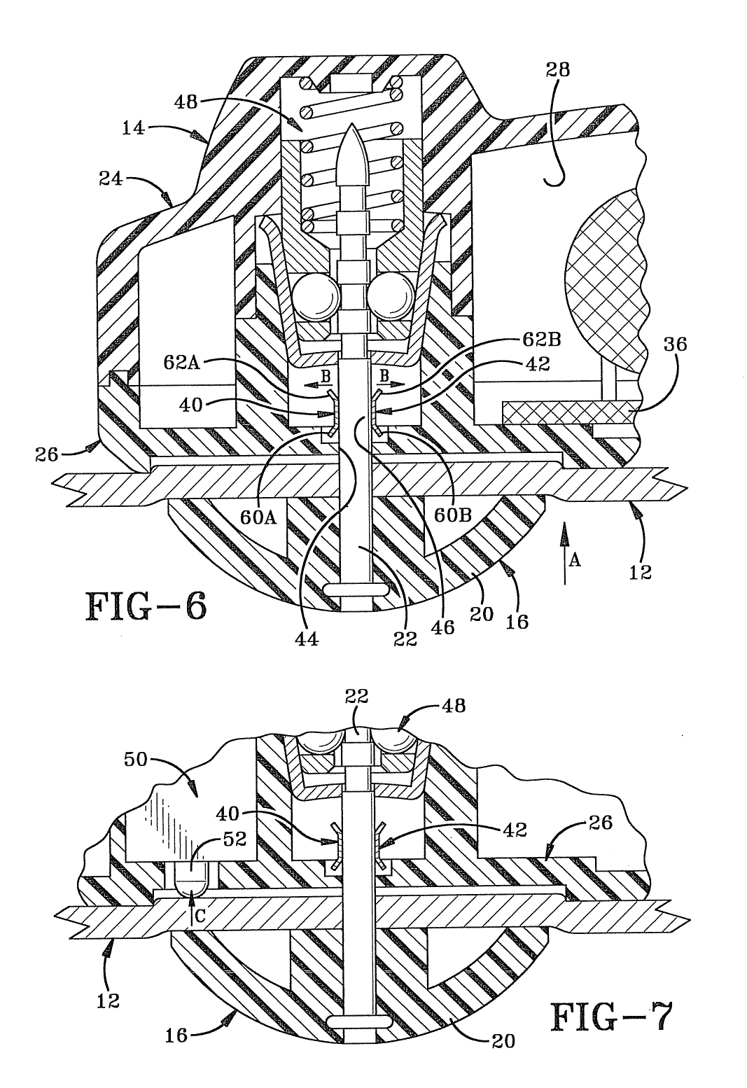

The operation of device 10 is described with reference to FIGS. 5-9. FIG. 5 shows device 10 prior to the insertion of post 22 of tack 16 through cloth 12 and into opening 44 and space 46. FIG. 6 shows tack 16 having moved as indicated at Arrow A to insert post 22 through opening 44 and space 46 into locking mechanism 48 whereby the balls of mechanism 48 lockingly engage the stepped portion of post 22 to lock first and second members 14 and 16 to one another and secure them to cloth 12. Locking mechanism 48 may be unlocked by a magnetic key in order to release tack 16 from locking mechanism 48 to allow the removal of first and second members 14 and 16 from one another. Post 22 contacts each of electrical contacts 40 and 42 upon insertion through space 46 and causes contacts 40 and 42 to flexingly spread apart from one another as indicated at Arrows B in FIG. 6. The resilient force of members 56 and 58 ensures that this electrical contact is maintained while first and second members 14 and 16 are secured to one another. Post 22 is electrically conductive and thus completes an electrical circuit or sense loop between contacts 40 and 42 to cause battery 34 to power PCB 36 and the rest of the alarm system. This completion of the circuit or sense loop occurs upon the first contact of post 22 with contacts 40 and 42. As tack 16 is fully inserted, head 20 thereof depresses plunger 52 through cloth 12 as indicated at Arrow C in FIG. 7. Depression of plunger 52 either opens or closes an electrical circuit to arm device 10 so that it is ready to sound an alarm should a potential thief try to tamper with device 10 by prying tack 16 or cutting post 22 thereof, which would allow spring-biased plunger 52 to move to its non-depressed position.

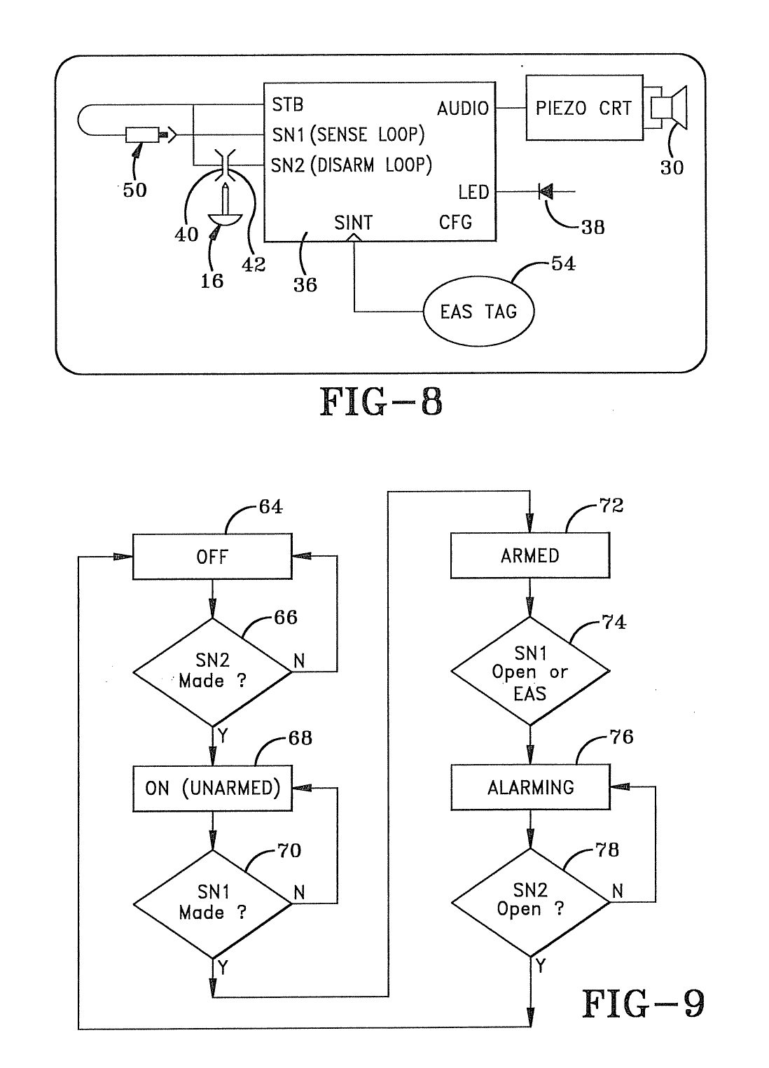

Referring to FIG. 8, the electrical circuitry of the alarm system is further described. When first and second members 14 and 16 are removed from one another so that post 22 is not completing the electrical circuit between contacts 40 and 42, device 10 is in a standby or off state. Battery 34 will typically send a pulsing signal to check whether the electrical circuits have been completed upon insertion of tack 16 into first member 14. More particularly, the alarm system includes a sense loop SN1 which includes plunger switch 50 and a disarm loop or on/off loop SN2 which includes contacts 40 and 42.

Referring to FIG. 9, device 10 is in the off state as indicated at 64 when first and second members 14 and 16 are separated one from another and more particularly when post 22 is not in contact with contacts 40 and 42 to complete loop SN2. PCB 36 includes a logic circuit for checking to determine whether loop SN2 has been completed or not as indicated at 66. If not, device 10 remains in the off state. If loop SN2 has been completed by the insertion of post 22 into contact with contacts 40 and 42, PCB 36 senses the closing of loop SN2 so that device 10 has been turned on although it is unarmed at this initial state. PCB 36 then checks to see if sense loop SN1 has been completed as indicated at 70. If not, device 10 remains on but unarmed. If loop SN1 has been completed by the depression of plunger 50 via tack 16, device 10 is in an armed stated as indicated at 72.

Once in the armed state, PCB 36 checks to see whether loop SN1 is opened or whether EAS tag 54 has received a wireless signal from a security gate due to device 10 passing through the security gate or within a predetermined distance from the security gate, as indicated at 74. If any of these three conditions occurs, device 10 will sound an alarm via speaker 30 as indicated at 76. This onboard alarm is configured to continue sounding for a specific period of time, for instance ten minutes, so that even if a potential thief escapes from the store, the alarm will continue sounding in an adjacent area such as parking lots and the like. PCB 36 determines whether loop SN2 is open as indicated at 78. If not, the alarm continues to sound. If SN2 is open, then device 10 will return to its off state as indicated at 64.

Thus, when sense loop SN2 has been opened due to prying or the cutting of post 22 so that plunger 52 moves to its non-depressed position, device 10 will continue to sound an alarm unless post 22 is removed from space 46 out of contact with contacts 40 and 42 in order to open loop SN2. This may be done by store personnel with the appropriate key.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

What is claimed is:

1. A security tag comprising:
a tag body having an upper portion and a lower portion secured together to form an interior chamber, wherein the upper portion is formed with an array of holes adjacent a first end of the upper portion, wherein a protrusion is formed at a second end of the upper portion; and, wherein a tack hole is formed in the lower portion in alignment with the protrusion of the upper portion;
a secure tack having a tack head and a tack post extending from the tack head adapted to be inserted into the tack hole in the lower portion;
a light emitting diode (LED) configured to project light through an LED opening in the upper portion;
a locking mechanism at least partially located within an interior chamber of the protrusion in the upper portion adapted to secure the secure tack to the tag body when the tack post is inserted through the tack hole in the lower portion;
an electrical contact located within the interior chamber of the tag body adapted to contact the tack post when the tack post is inserted into the tack hole;
a plunger switch located within the interior chamber of the tag body adapted to close when the secure tack is secured to the tag body; and
an alarm system configured to generate the alarm when the tack post is removed from contact with the electrical contact, the plunger switch is opened or the security tag is moved into range of a signal emitted by a security gate.

2. The security tag of claim 1 wherein the locking mechanism comprises:
at least one metal ball; and
a spring adapted to bias the metal ball into contact with the tack post to secure the secure tack to the tag body.

3. The security tag of claim 1 in combination with a magnetic key wherein the secure tack is adapted to be removed from the tag body when the magnetic key is adjacent the protrusion in the upper portion.

4. The security tag of claim 1 wherein the LED opening is between the protrusion of the upper body and the array of holes.

5. The security tag of claim 1 wherein the array of holes is a generally circular array of holes.

6. The security tag of claim 1 wherein the electrical contact comprises:
a pair of electrical terminals, and wherein the tack post abuts the pair of electrical terminals to provide an electrical pathway to close a first electrical circuit, and wherein the alarm system will generate the alarm when the first electrical circuit is opened.

7. The security tag of claim 1 wherein the plunger switch comprises:
a plunger that protrudes through a plunger hole in the lower portion, wherein the plunger is spring biased and the plunger switch closes when the secure tack is secured to the tag body.

8. The security tag of claim 1 wherein the alarm system further includes a printed circuit board (PCB) having the LED mounted thereon.

9. The security tag of claim 1 wherein the alarm includes a battery and a piezo speaker mounted in the upper portion of the tag body with the piezo speaker aligned with and adjacent to the array of holes in the upper portion.

10. The security tag of claim 9 wherein the audible alarm is generated by the speaker.

11. The security tag of claim 1 wherein the tack post is adapted to pass at least partially into the protrusion on the upper portion when the secure tack is attached to the tag body.

12. The security tag of claim 1 wherein the tack head is generally a round flat disk.

13. The security tag of claim 1 wherein the tag body has an elongated configuration with a first end having a curved configuration and a second end having a substantially straight configuration with the upper and lower portions of the tag body being secured together providing a seam extending about a periphery of the tag body.

14. The security tag of claim 1 further comprising:
an electronic article surveillance (EAS) tag configured to detect when the security tag is moved into into range of the signal emitted by the security gate.

15. The security tag of claim 1 wherein the protrusion of the upper portion is generally spherical.

16. The security tag of claim 1 wherein the plunger switch is actuated by a plunger which projects outwardly from the lower portion of the tag body and is located closely adjacent the tack hole.

17. The security tag of claim 16 wherein the alarm logic is configured to turn on the security tag when the electrical contact is in contact with the tack post, and wherein the alarm logic is configured to arm the security tag when the plunger switch is closed.

18. The security tag of claim 1, wherein the LED is configured to turn on when the security tag is turned on and to blink when the security tag is alarmed.

19. A security tag comprising in combination with a security gate configured to produce a wireless signal:
a first tag element comprising a post;
a second tag element securable to the first tag element in a secured position;
a pair of spaced electrical contacts carried by the second tag element;
a post-receiving opening formed in the second tag element for receiving the post therein in the secured position so that the post abuts each of the electrical contacts to provide an electrical pathway therebetween to close a first electrical circuit;
an onboard audible alarm; and
an onboard EAS tag configured to receive the wireless signal within a predetermined distance of the gate to activate the onboard alarm, wherein the security gate comprises an alarm which sounds when the device is within the predetermined distance of the gate.

20. The security tag of claim 19 wherein the second tag element further comprises:
a locking mechanism comprising:
at least one metal ball;
a spring adapted to bias the metal ball into contact with the post of the first tag element; and
wherein the first tag element is adapted to be removed from the second tag element when a magnetic key is adjacent the locking mechanism.
